(19) United States
(12) Patent Application Publication
(10) Pub. No.: US 2002/0194622 A1
(43) Pub. Date: Dec. 19, 2002

(54) Communication system for public places and advertising based revenue generation model for use therewith

(76) Inventor: Allan Dale Lord, Dallas, TX (US)

Correspondence Address: Allan Dale Lord c/o RAVE USA, Suite 766, 2118 Wilshire Blvd., Santa Monica, CA, 90403, US

(21) Appl. No.: 10/145,984

(22) Filed: May 14, 2002

Related U.S. Application Data
(60) Provisional application No. 60/293,199, filed on May 25, 2001.

(51) Int. Cl. H04N 7/18; H04N 7/16; H04N 5/445; H04N 5/45

(52) U.S. Cl. 725/143; 725/151; 725/74; 348/564; 348/565

(57) ABSTRACT

A multicast network including a network controller for selectively merging a first data stream with a second data stream to create a third data stream. The network is designed to multicast the third data stream to a predetermined number of receivers. A number of displays are operationally coupled to the receivers. Each of the displays is mounted in a publicly accessible location. In the illustrative embodiment, the first data stream is a network television feed and the second data stream is a proprietary, third party feed with advertising content. The system is designed to simultaneously display the first data stream and the second data stream on onscreen. In the preferred embodiment, the screen is split vertically or horizontally on multiple screens.

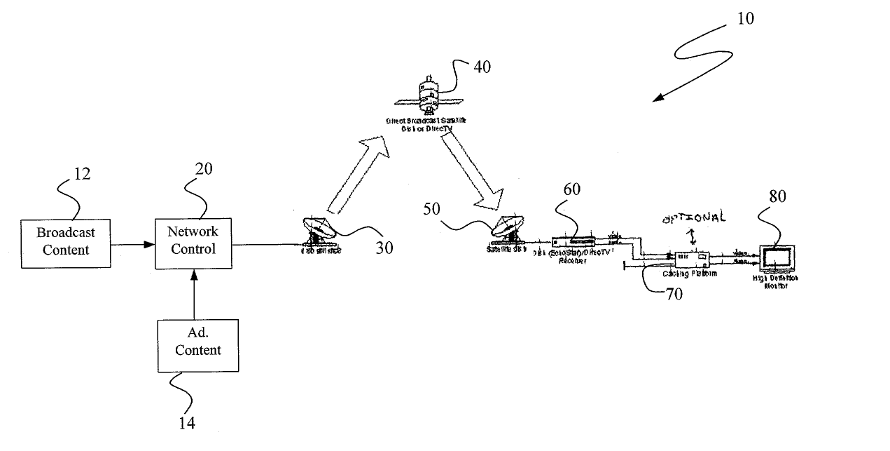

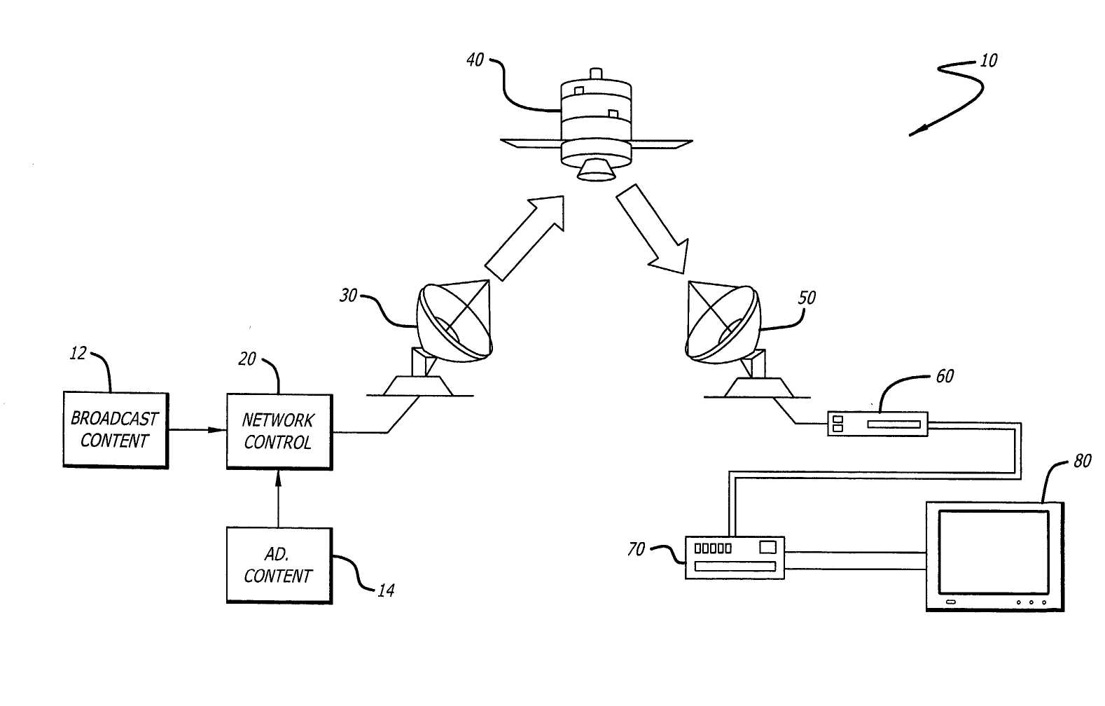

### REFERENCE TO COPENDING APPLICATION

The present application claims priority from a provisional application serial No. 60/293,199, filed May 25, 2001, by the present Applicant and entitled RAVE ON THE WALL NETWORK.

### BACKGROUND OF THE INVENTION

1. Field of the Invention

The present invention relates to communications systems. More specifically, the present invention relates to broadcast communication systems.

2. Description of the Related Art

Broadcast communication systems currently generate revenue through the use of a conventional advertising model, which is tied to a Nielsen rating associated with a program on which the ad is run. The Nielsen rating is acquired by sampling viewership and estimating or projecting total actual viewership for any given program at any given point in time. Advertising time is sold on the basis of the number of impressions provided during the ‘spot’ within which the ad is run.

Unfortunately, as is well known in the art, inasmuch as the Nielsen rating is based on a sampling and a statistical projection, it is somewhat inaccurate and less accurate than a system by which actual viewership is measured directly. For example, it is well known in the industry that the effectiveness of billboards ads may be more accurately monitored by simply counting the number of passersby that are able to see the ad during a given time period. Further, with videocassette recorders (VCRs), digital video recorders (DVRs) such as TiVo and Ultimate TV, it is difficult for advertisers to ensure that ads are actually being viewed.

Thus, there is a need in the art for a system or method for improving the viewership rating of video spot advertising. Further, there is an ongoing need in the advertising industry for systems and methods for providing more channels to increase exposure for advertisements.

### SUMMARY OF THE INVENTION

The need in the art is addressed by the multicast network of the present invention. Generally, the inventive network includes a network controller for selectively merging a first data stream with a second data stream to create a third data stream. The network is designed to multicast the third data stream to a predetermined number of receivers. A number of displays are operationally coupled to the receivers. Each of the displays is mounted in a publicly accessible location.

In the illustrative embodiment, the first data stream is a network television feed and the second data stream is a proprietary, third party feed with advertising content. The system is designed to simultaneously display the first data stream and the second data stream on onscreen. In the preferred embodiment, the screen is split vertically or horizontally in various sizes.

The present invention also provides a novel revenue generation model including the steps of providing the above-identified multicast network and inserting advertising content in the second data stream for a fee.

### BRIEF DESCRIPTION OF THE DRAWINGS

The FIGURE is a block diagram showing an illustrative embodiment of a network topology implemented in accordance with the teachings of the present invention.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

The FIGURE is a block diagram showing an illustrative embodiment of a network topology implemented in accordance with the teachings of the present invention. As shown in the FIGURE, the network 10 includes a network controller 20 which selectively merges a first data stream from a first source 12, having broadcast content, with a second data stream, from a second proprietary source 14, to create a third data stream. In the illustrative embodiment, the first data stream is a network television feed and the second data stream is a custom, third party generated, proprietary feed with advertising content.

In the illustrative embodiment, the network controller 20 feeds the third data stream to a satellite dish 30 for uplink to a satellite 40. The satellite 40 multicasts the received data stream to a predetermined number of receiving dishes of which only one is shown at 50. Each receiving dish 50 feeds a receiver 60 which downconverts and decodes the data stream and feeds and associated display 80 through an optional caching platform 70. In the illustrative embodiment, the receiver 60 is a Direct TV satellite receiver.

In the best mode, each display is a large flat-panel liquid crystal display such as a Pioneer PDP V402 40 inch plasma VGA display or PDP-502MX 50 inch plasma XGA display. A mechanism is provided to mount each of the displays in a publicly accessible location. This mechanism (not shown) could be implemented with any one of a number of commercially available wall or ceiling mount kits including the Pioneer PDWB-5001 wall mount kit or the Pioneer PDK-5002 ceiling mount kit by way of example or placed in a kiosk.

The system 10 is designed to simultaneously display the first data stream and the second data stream onscreen. In the preferred embodiment, the screen is split vertically. That is, the first and second data streams are combined in such a way that when displayed, the screen is split vertically. Those skilled in the art will appreciate, however, that the screen may be split horizontally or in a variety of other matters (e.g. a window) without departing from the scope of the present teachings. As yet another alternative, the first data stream may be blanked from the screen altogether while the second data stream is displayed.

The present invention also provides a novel revenue generation model including the steps of providing the above-identified multicast network and inserting advertising content in the second data stream for a fee. This fee may be shared with the owner or manager of the publicly accessible building within which the display is located.

In any event, unlike a conventional broadcast network, for which a Nielsen type rating system must be used, in accordance with the present teachings, inasmuch as the displays are mounted in publicly accessible locations, contrary to closed-loop systems, viewership may be actually monitored by tracking the number of people moving within viewing range of a display. Thus, those skilled in the art will appreciate that the present invention:

1) provides new channels for reaching an audience with advertising content;

2) allows for more accuracy for consumers to see the electronic displays then traditional static advertising;

3) allows for more accuracy for customers recall for advertising shown on the screens then that which is shown on televisions in homes;

4) allows for more accuracy in ratings with respect to viewership of programs and advertisements displayed;

5) allows for more accuracy in ratings with respect to viewership of advertisements inasmuch as the ads may not be muted, deleted or skipped;

6) provides an additional source of revenue for the owner or manager of a publicly accessible building; and

7) brings information and entertainment content to publicly accessible places (this may increase traffic in these areas which are typically devoid of an interesting or appealing audio or video stimulus).

8) promises to deliver a sense of immediacy not possible with static displays.

Thus, the present invention has been described herein with reference to a particular embodiment for a particular application. Those having ordinary skill in the art and access to the present teachings will recognize additional modifications, applications and embodiments within the scope thereof. The invention is able to also incorporate static displays incorporated in the feed to overlay on the split screens on a combination of two screens. The invention is also adapted to enable communication with digital devices via infrared transmitters installed in the large screen display.

It is therefore intended by the appended claims to cover any and all such applications, modifications and embodiments within the scope of the present invention.

Accordingly,

What is claimed is:

1. A multicast network comprising:
means for selectively merging a first data stream with a second data stream to create a third data stream;
means for multicasting said third data stream over a network;
a predetermined number of receivers adapted to receive said third data stream;
a predetermined number of displays, each display being operationally coupled to a respective one of said receivers; and
means for mounting each of said displays in a publicly accessible location.

2. The invention of claim 1 wherein said first data stream is a network television feed.

3. The invention of claim 1 wherein said second data stream is a proprietary, third party feed.

4. The invention of claim 3 wherein said proprietary, third party feed contains advertising content.

5. The invention of claim 1 including means for simultaneously displaying said first data stream and said second data stream on said display.

6. The invention of claim 5 wherein said means for simultaneously displaying includes means for segmenting said display on a screen.

7. A multicast network comprising:
means for selectively merging a first data stream including a network television feed with a second proprietary, third party data stream containing advertising content to create a third data stream;
means for multicasting said third data stream over a network;
a predetermined number of receivers adapted to receive said third data stream;
a predetermined number of displays, each display being operationally coupled to a respective one of said receivers;
means for simultaneously displaying said first data stream and said second data stream on said display; and
means for mounting each of said displays in a publicly accessible location.

8. The invention of claim 7 wherein said means for simultaneously displaying includes means for segmenting said display on a screen.

9. A method for generating revenue including the steps of:
providing a private multicast network comprising:
means for selectively merging a first data stream with a second data stream to create a third data stream;
means for multicasting said third data stream over a network;
a predetermined number of receivers adapted to receive said third data stream;
a predetermined number of displays, each display being operationally coupled to a respective one of said receivers; and
means for mounting each of said displays in a publicly accessible location and inserting advertising content in said second data stream for a fee.

10. The invention of claim 9 wherein said first data stream is a network television feed.

11. The invention of claim 9 wherein said second data stream is a proprietary, third party feed.

12. The invention of claim 9 including the step of simultaneously displaying said first data stream and said second data stream on said display.

13. The invention of claim 12 wherein the step of simultaneously displaying includes the step of segmenting said display on a screen.
